(19) United States
(12) Patent Application Publication
(10) Pub. No.: US 2018/0328083 A1
(43) Pub. Date: Nov. 15, 2018

(54) SECURING RACK FOR BACKPACK BLOWER

(71) Applicant: Service Industry Solutions LLC, Riviera Beach, FL (US)

(72) Inventor: David Sargent, Riviera Beach, FL (US)

(21) Appl. No.: 15/592,764

(22) Filed: May 11, 2017

(51) Int. Cl. E05B 73/00; B60R 7/08; A47B 81/00

(52) U.S. Cl. CPC E05B 73/00; A47B 81/00; B60R 7/08

(57) ABSTRACT

A lockable equipment rack configured to secure equipment, such as a backpack blower, thereto. The lockable equipment rack, designed to fit multiple backpack blower equipment styles without the need of additional brackets or parts, comprises a locking rack body configured to maintain equipment in a secured position when engaged therewith. The locking rack body comprises an upper shaft configured to engage with at least one first portion of said equipment; a lower shaft configured to engage with at least one second portion of said equipment; upper and lower equipment securing members; and a locking unit configured to maintain the upper equipment securing member in a locked or unlocked position, and having a locking rack body upper shaft contacting member configured to engage with the locking rack body upper shaft in a locked position, and disengage with the locking rack body upper shaft in an unlocked position.

### FIELD OF THE INVENTION

The present invention relates to equipment racks; more particularly, to lockable equipment racks configured to secure a backpack blower thereto.

### BACKGROUND OF THE INVENTION

Lawn care service providers utilize multiple types of equipment to properly maintain a lawn or outdoor landscape. Some pieces of equipment, such as lawn mowers, are large and heavy enough that the risk of theft is low; other types of equipment, such as trimmers or backpack blowers, are small enough that theft of such items is a real concern. Given their size, easy portability, and cost, it is very beneficial for companies to somehow secure such items in order to prevent loss while at a job site. This is particularly important for companies that remain on a particular job site for extended periods of time and use multiple types of equipment.

One mechanism to keep easily portable items from theft would be to lock them up within a vehicle. While simple in nature, execution can be difficult as lawn care vehicles are often left open to move equipment in and out quickly, use open air trailers in transporting landscaping equipment, or are unattended for extended periods of time. All this leads to difficulty in simply locking equipment within a vehicle. Alternatively, specialized locking equipment can be utilized to secure such items to a vehicle, regardless if using an open air trailer. For example, U.S. Pat. No. 7,762,408 and U.S. Pat. No. 8,245,859 describe specialized locking equipment racks for use with trimmers. Other equipment, like backpack blowers, require a specialized equipment rack to properly secure the devices. U.S. Pat. No. 9,045,918 illustrates an example of a locking equipment rack for use with backpack blowers. The design of the '918 patent was bulky, cumbersome, and could not be adapted to fit multiple backpack blower brands without the need of additional brackets or parts.

### SUMMARY OF THE INVENTION

The present invention relates to lockable equipment racks configured to secure equipment, such as a backpack blower, thereto. In one illustrative embodiment, a device for locking equipment comprises a locking rack body configured to maintain equipment in a secured position when engaged therewith. The locking rack body comprising: an upper shaft configured to engage with at least one first portion of the equipment; a lower shaft configured to engage with at least one second portion of the equipment; an upper equipment securing member configured for over-the-top engagement with a piece of equipment; a lower equipment securing member; and a locking unit configured to maintain the upper equipment securing member in a locked or unlocked position about the locking rack body upper shaft. The locking unit has a locking rack body upper shaft contacting member configured to engage with the locking rack body upper shaft in a locked position, and disengage with the locking rack body upper shaft in an unlocked position.

Accordingly, it is an objective of the invention to provide an equipment rack configured to secure equipment.

It is a further objective of the invention to provide a lockable equipment rack configured to secure equipment.

It is yet another objective of the invention to provide a lockable equipment rack configured to secure a backpack blower.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of an illustrative embodiment of a locking equipment rack;

FIG. 2 is an alternative partial view of the locking equipment rack shown in FIG. 1;

FIG. 3 is an alternative partial view of the locking equipment rack shown in FIG. 1;

FIG. 4 is an alternative partial view of the locking equipment rack shown in FIG. 1;

FIG. 5 is an alternative partial view of the locking equipment rack shown in FIG. 1;

FIG. 6A is an exploded view of an illustrative example of a locking mechanism;

FIG. 6B illustrates the locking mechanism in a locking position;

FIG. 6C illustrates the locking mechanism in an unlocking position;

FIG. 6D is a close view of the cam;

FIG. 7 is a partial view of the locking equipment rack, illustrated with the lower portion of a locking rack body secured to a cargo bed of an open air truck;

FIG. 8 illustrates the locking equipment rack positioned within a closed trailer, box truck, or on a flat wall;

FIG. 9A illustrates the upper equipment securing member in a first position;

FIG. 9B illustrates the upper equipment securing member rotated 45 degrees from the position shown in FIG. 9A;

FIG. 9C illustrates the upper equipment securing member rotated 180 degrees from the position shown in FIG. 9A;

FIG. 10 illustrates the locking equipment rack secured to a backpack blower.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

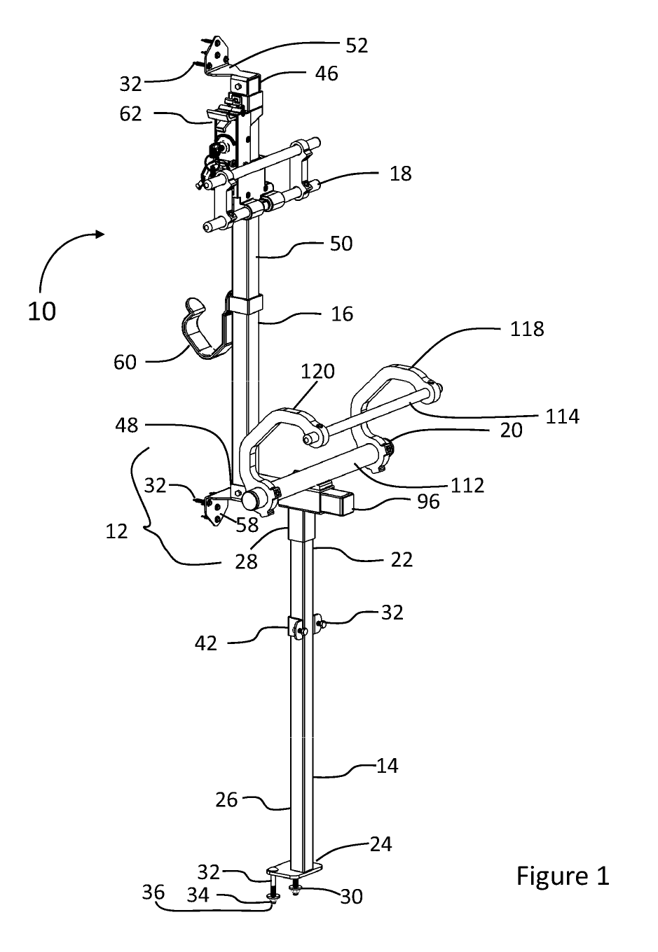

FIG. 1 illustrates an embodiment of an equipment rack, referred to generally as a locking equipment rack 10. The locking equipment rack 10 includes a locking rack body 12 having a lower shaft 14 and an upper shaft 16. A plurality of equipment securing members, including an upper equipment securing member 18 and a lower equipment securing member 20, secured to a portion of the locking rack body 12 are configured to adjustable fit to one or more portions of a piece of equipment. The lower shaft 14 of the locking rack body 12 comprises a first end 22, an opposing second end 24, and a lower shaft body 26 there between. The first end 22 secures to a portion of the upper shaft 16 through a T-shaped bracket 28. The opposing second end 24 contains a plate 30. Carriage bolt(s) 32 with nut(s) 34 and washer(s) 36 secure the lower shaft 14 to a surface 38 (see FIG. 7), illustrated herein as a bed of an open trailer 40. Alternatively, the surface 38 could be the floor of a closed vehicle, such as a transportation truck. A U-shaped bracket 42 secured to a rail (or side wall) of the open trailer 40 by use of carriage bolt(s) 32 maintains the lower shaft 14 in a secure and stable position, see FIG. 7.

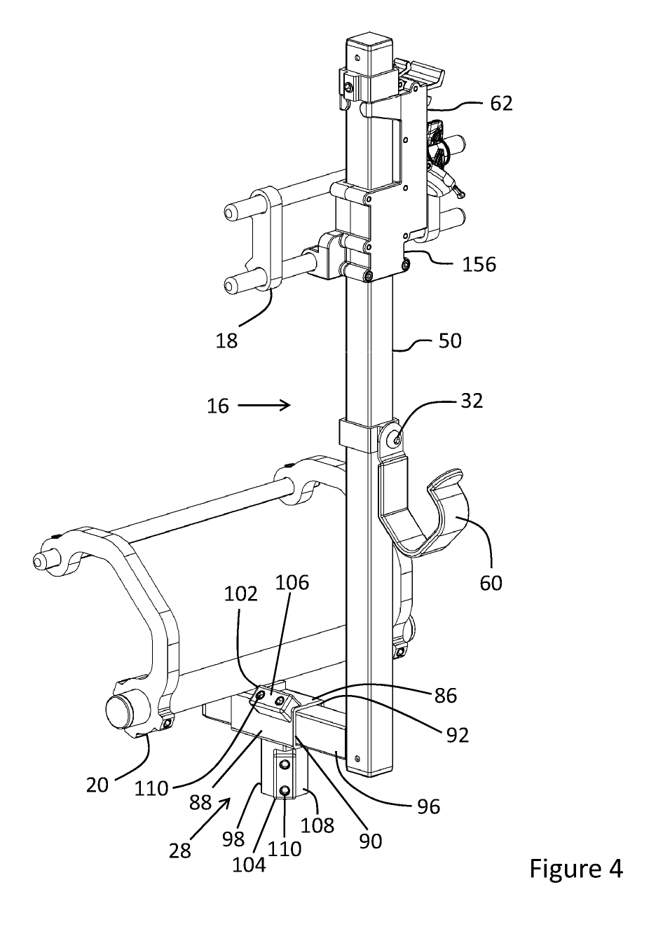

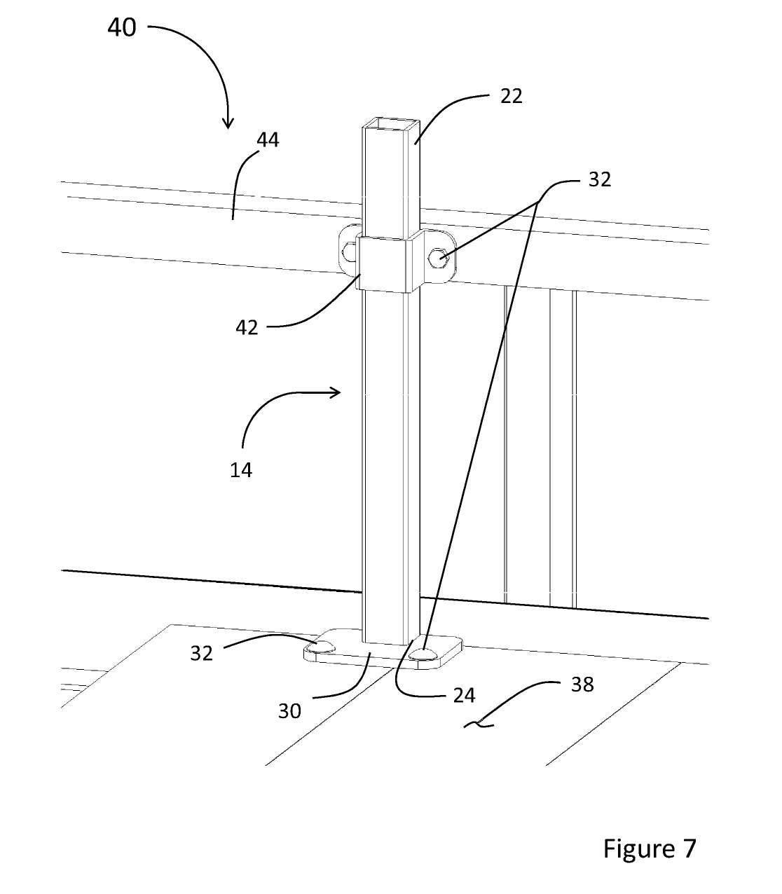

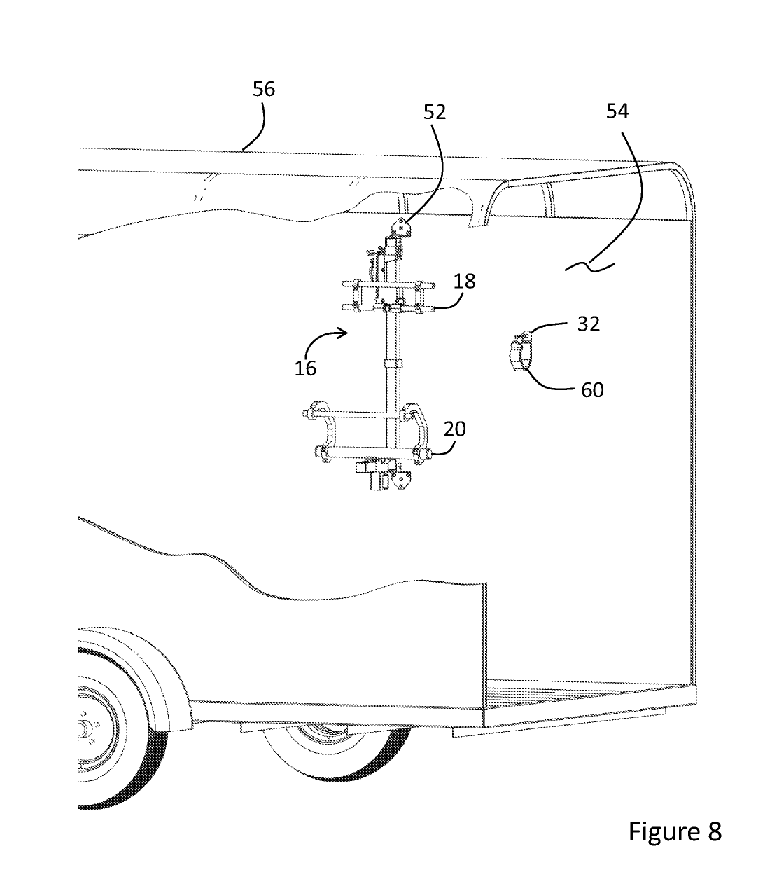

The upper shaft 16 of the locking rack body 12 comprises a first end 46, a second opposing end 48, and an upper shaft main body 50. The first end 46 may contain a bracket 52 which secures to a surface 54, illustrated in FIG. 8 as a wall of a closed trailer 56, via carriage bolt(s) 32. Alternatively, the surface 54 may be a wall of a box truck, or any flat wall associated with a vehicle transporting equipment that requires such equipment to be locked up to prevent unwanted removal or theft. A second bracket 58 positioned at the second opposing end 48 provides a second point of attachment/securing to the surface 54. The second bracket 58 secures to the surface 54 by use of one or more carriage bolts 32. The upper shaft main body 50 may also contain a hose clip 60. The hose clip 60 is sized and shaped to receive and hold a hose, such as a blower hose, associated with a piece of equipment. The hose clip 60 is removable secured to a portion of the upper shaft main body 50 by use of a carriage bolt 32, see FIG. 4. Prior to securing the upper shaft main body 50 to the surface 54, the hose clip 60 can be removed. Once the upper shaft main body 50 is properly secured to the surface 54, the hose clip 60 can be secured to the surface 54 as well, see FIG. 8.

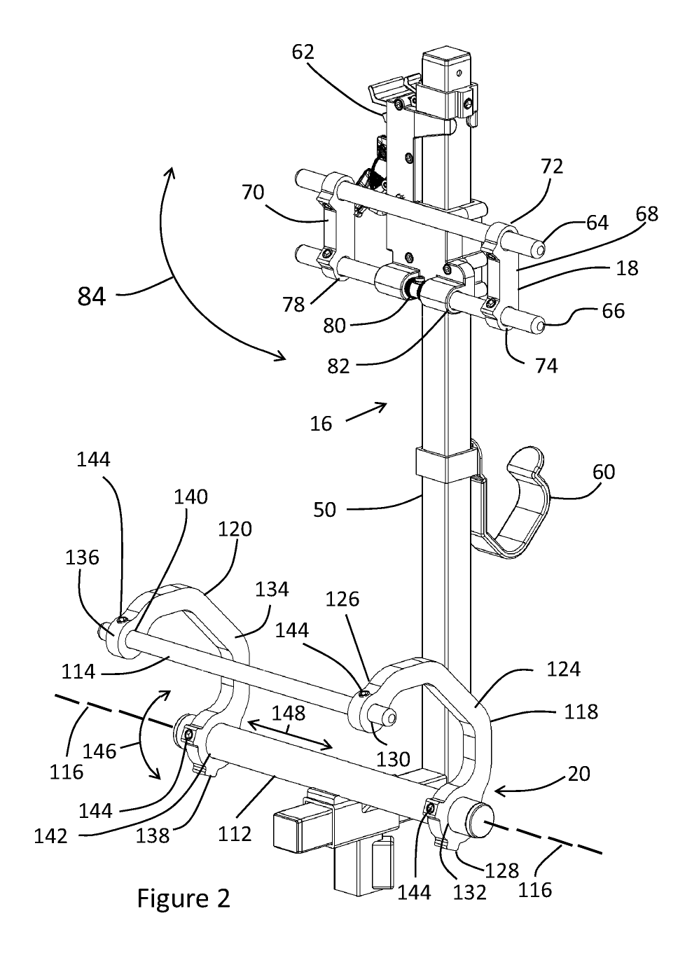

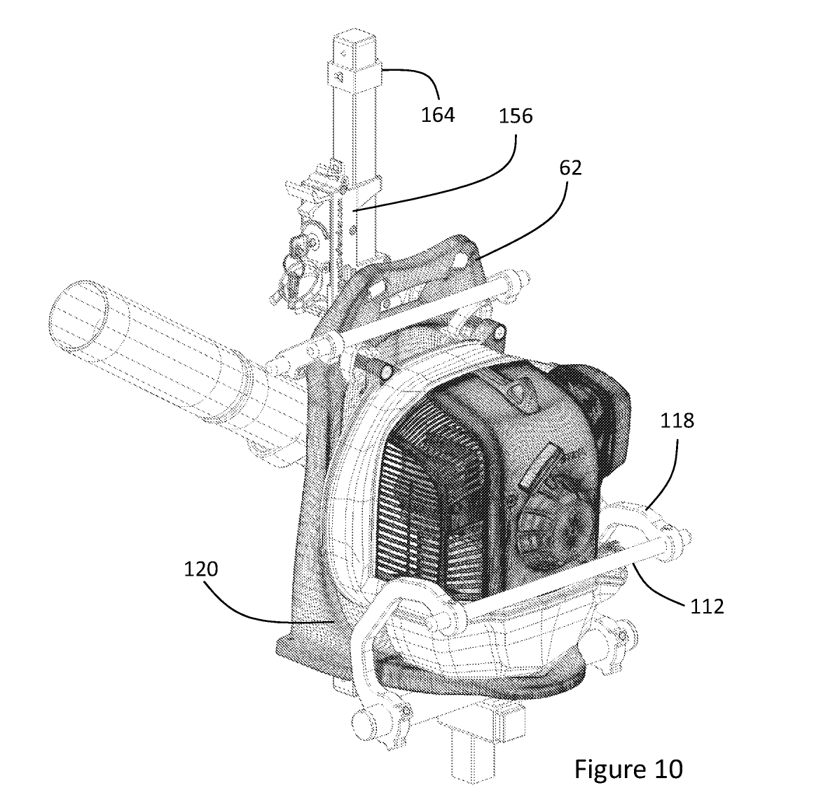

Referring to FIG. 2, the upper equipment securing member 18 is slidably mounted to the upper shaft 16 by use of a locking unit 62 and is designed for an over-the-top engagement with a piece of equipment. The upper equipment securing member 18 is configured to engage with a portion of a backpack blower (see FIG. 10). The upper equipment securing member 18 comprises two elongated bars 64 and 66 separated by a distance and space, and preferably arranged in a parallel orientation. A pair of brackets 68 and 70 maintains the two elongated bars 64 and 66 in a preferred orientation. Each bracket 68 and 70 contains openings 72, 74, 76, and 78 sized and shaped to receive and support at least a portion of elongated bar 64 or elongated bar 66. One of the elongated bars 64 and 66 secures to a portion of the locking unit 62 through openings 80 and 82.

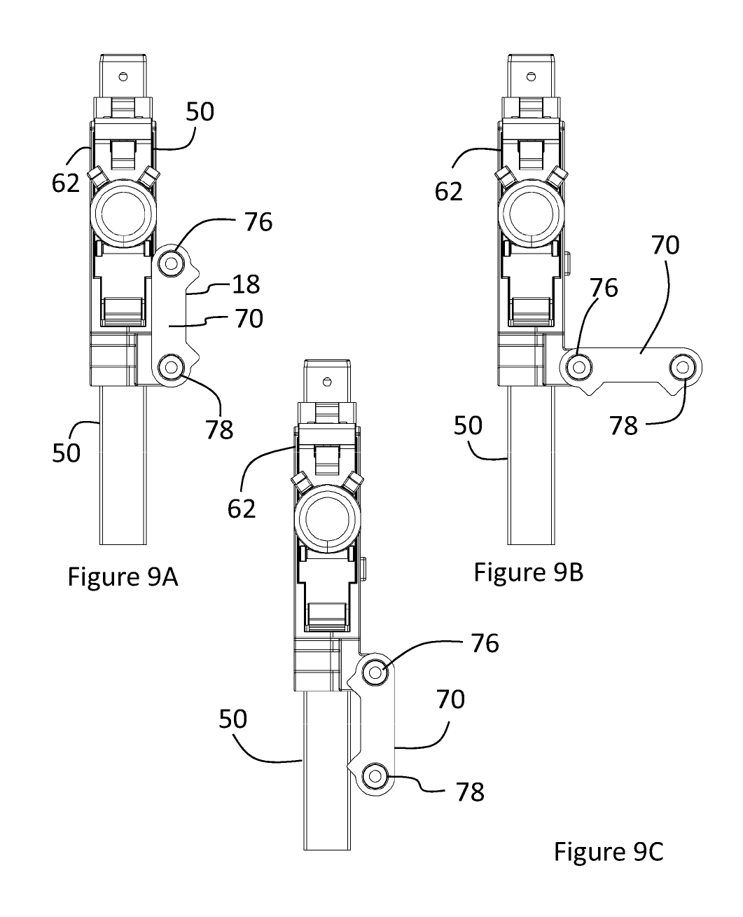

Securing through openings 80 and 82 allows the upper equipment securing member 18 freedom to rotate at least 180 degrees, see double arrow 84, FIG. 2. FIGS. 9A, 9B, and 9C illustrate the upper equipment securing member 18 placed in various positions. As shown in FIG. 9A, the upper equipment securing member 18 is illustrated in a first position, in which bracket 70, and thus the elongated bar 64 or elongated bar 66, is orientated to be parallel with the upper shaft main body 50. As the bracket 70 is rotated in a direction down and away from the upper shaft main body 50, see FIG. 9B, bracket 70 and elongated bar 64 or elongated bar 66 are orientated at an angle from the upper shaft main body 50. FIG. 9C illustrates the bracket 70 rotated 180 degrees from the position illustrated in FIG. 9A.

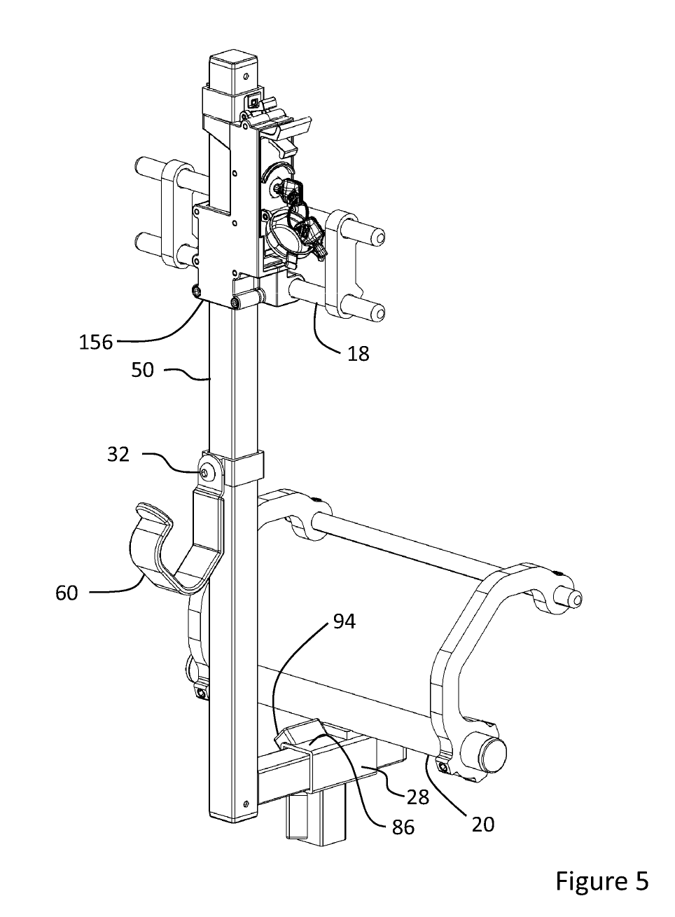

The lower equipment securing member 20 is configured to engage with and secure a different portion of the piece of equipment than the upper equipment securing member 18. The lower equipment securing member 20 is secured to an upper surface 86 of the T-shaped bracket 28, see FIG. 4 or FIG. 5. The T-shaped bracket 28 is designed to link a portion of the locking rack body lower shaft 14 with the locking rack body upper shaft 16. A horizontal arranged bar 88 of the T-shaped bracket 28 contains an internal lumen 90 having openings 92 and 94 at each end. The internal lumen 90 is sized and shaped to receive a locking rack body lower shaft horizontal extension arm 96. The locking rack body lower shaft horizontal extension arm extends outwardly from the upper shaft main body 50, preferably at, near, or towards the second opposing end 48, thus providing an overall L-shaped configuration for the upper shaft 16. The locking rack body lower shaft horizontal extension arm 96, however, may be positioned anywhere along the upper shaft main body 50. The internal lumen 90 preferably has a diameter larger than the diameter of the locking rack body lower shaft horizontal extension arm 96 so that the locking rack body lower shaft horizontal extension arm 96 can rest and slide within. Moving the T-shaped bracket 28 along the length of the locking rack body lower shaft horizontal extension arm 96 allows for securing different sized equipment, i.e. backpack blowers.

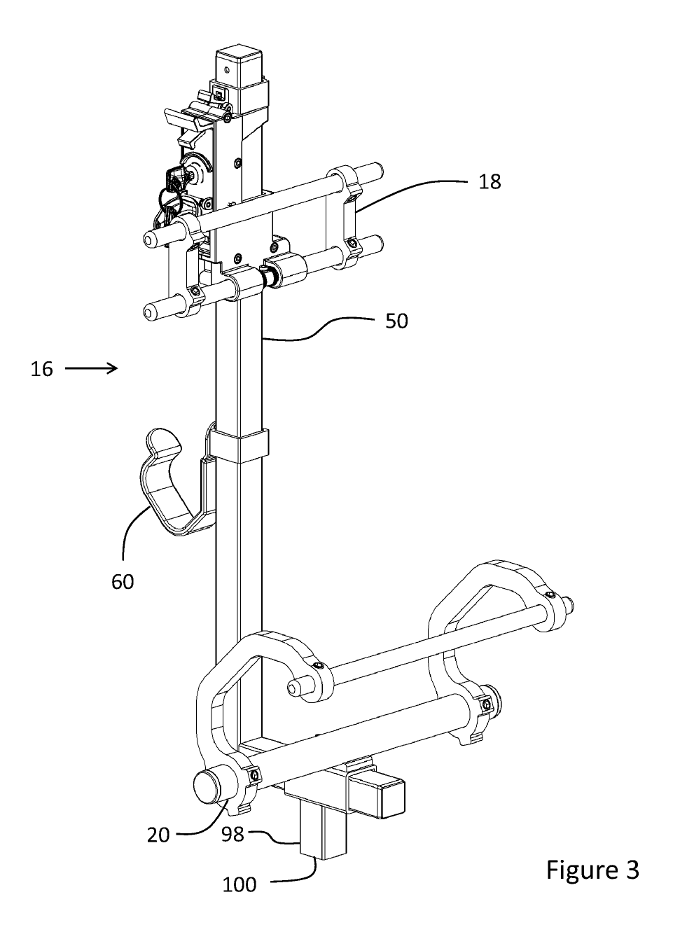

A vertical arranged bar 98 extends downwardly away from the horizontal arranged bar 88 and is configured to secure a portion of the lower shaft 14. The vertical arranged bar 98 comprises an internal lumen 100, see FIG. 3, for receiving and holding the lower shaft 14, see FIG. 1. Both the horizontal arranged bar 88 and the vertical arranged bar 98 can include a locking mechanism, 102, 104 to provide a mechanism to tighten the T-bar 28 against the lower shaft 14 or the upper shaft 16. The locking mechanisms 102, 104 each comprise a threaded block 106 or 108 having one or more screws 110 which extend inward into the respective lumen 90 or 100 and secure against the lower shaft 14 or upper shaft 16 when tightened. The threaded blocks 106 and 108 allow for mounting and adjusting the rack.

The lower equipment securing member 20 comprises a first bottom securing member 112, illustrated herein as an elongated rod, and a second, top securing member 114, illustrated herein as a second elongated rod. The first bottom securing member 112 and the second, top securing member 114 are oriented in a parallel manner, with the top securing member 114 orientated off center from the longitudinal axis 116 (FIG. 2) of the first bottom securing member 112 when in a locking position. A pair of lower equipment securing member support arms 118 and 120 support and maintain the positioning of the first bottom securing member 112 or the second, top securing member 114. Support arm 118 comprises a main body 124 having a first end 126 and a second end 128. Each end 126 and 128 has an opening 130 and 132. Opening 130 is sized and shaped to receive at least a portion of the top securing member 114. Opening 132 is sized and shaped to receive at least a portion of the first bottom securing member 112. Support arm 120 comprises a main body 134 having a first end 136 and a second end 138. Each end 136 and 138 has an opening 140 and 142. Opening 140 is sized and shaped to receive at least a portion of the top securing member 114. Opening 142 is sized and shaped to receive at least a portion of the first bottom securing member 112. Support arms 118 and 120 may also have one or more fastening device openings 144 for receiving a fastening member such as a screw (not illustrated). Tightening or loosening of an inserted screw provides several functions. In a loosen arrangement, the lower equipment securing member 20 can be moved in multiple directions. The lower equipment securing member 20 may be able to pivot or rotate, see arrows 146, FIG. 2, about the longitudinal axis 116 of the first bottom securing member 112. The lower equipment securing member 20 may be moved in a linear direction(s), see arrows 148, about the longitudinal axis 116 of the first bottom securing member 112. These movements help lock variously sized equipment therein. Tightening the screws locks the lower equipment securing member 20 in place.

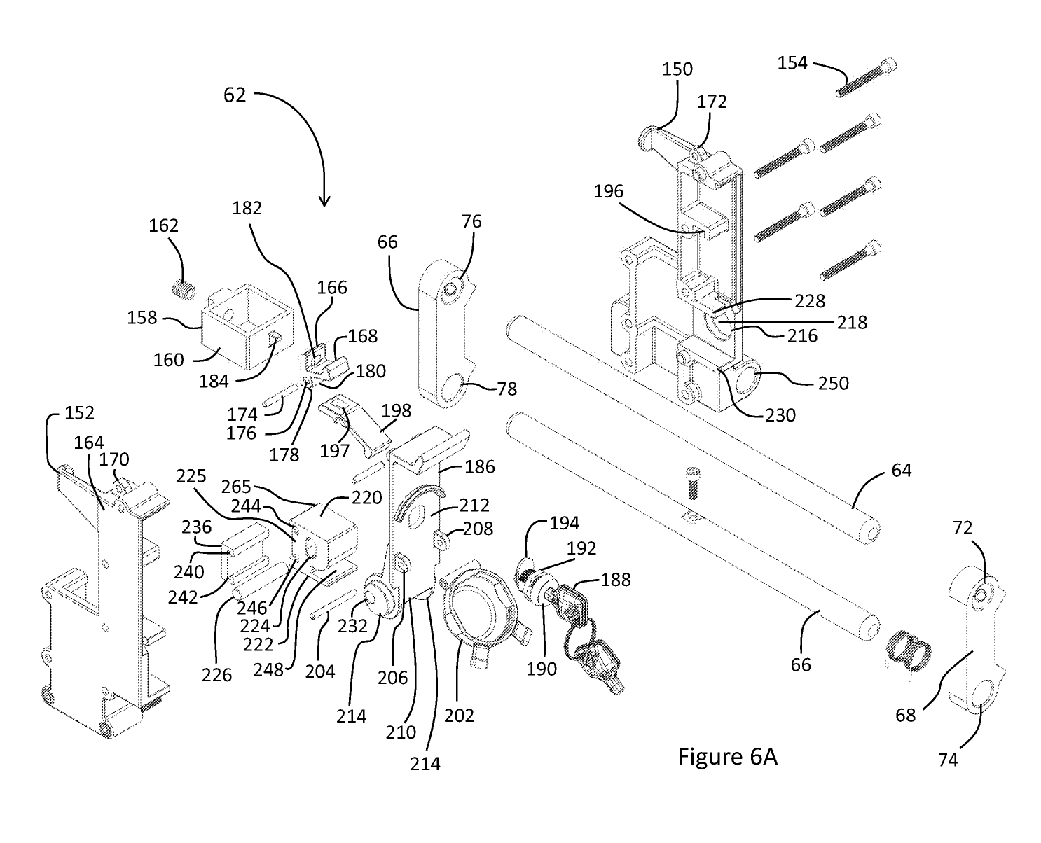

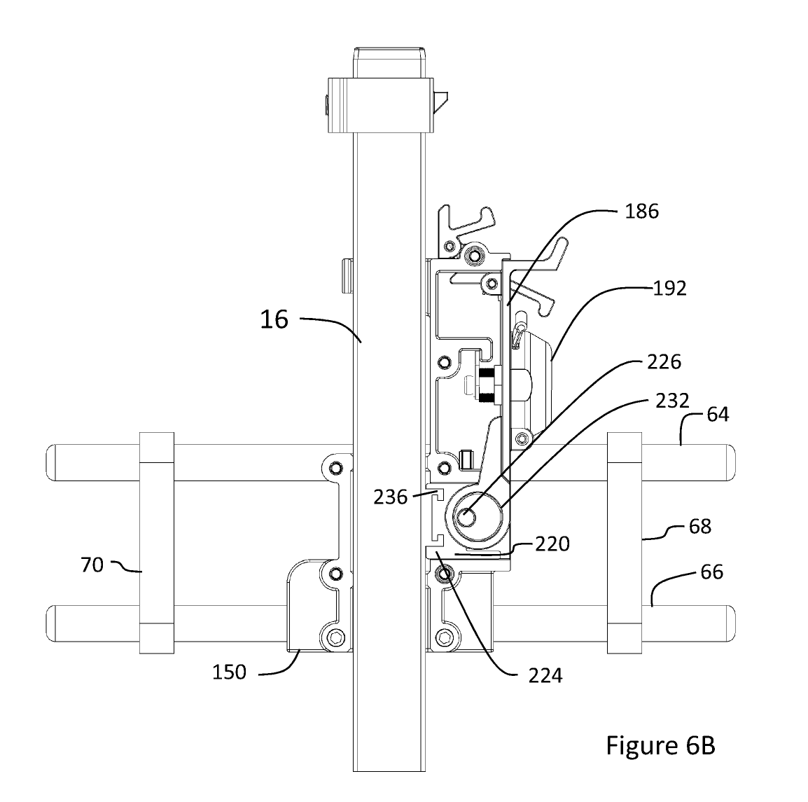

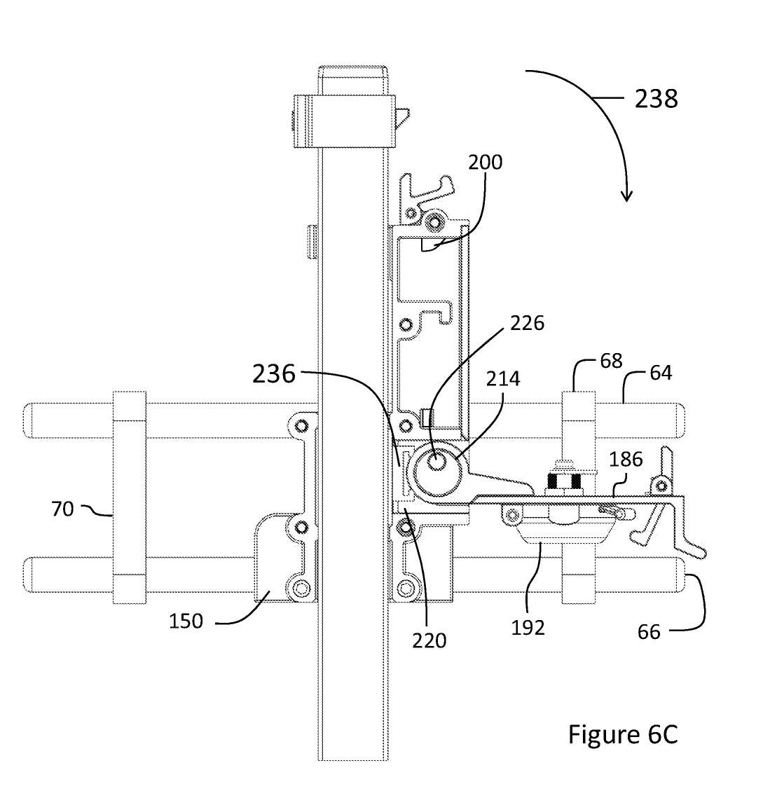

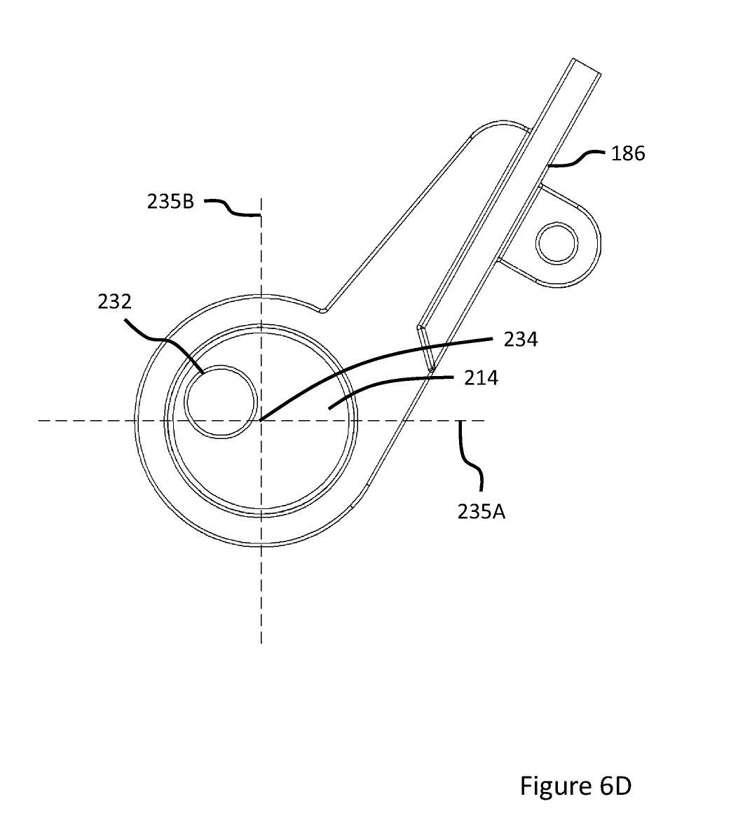

FIG. 6A is an exploded view of the locking unit 62. The locking unit 62 comprises two outer units 150 and 152 secured together using screws 154 to form a locking unit housing 156 (see also FIGS. 4 and 5). The locking unit housing 156 provides an enclosed unit which stores additional components. The locking unit housing 156 may engage a stop block 158. The stop block 158 comprises a body 160 which is secured to the upper shaft 16 of the locking rack body 12 through a set screw 162.

Secured to the upper end 164 of the locking unit housing 156 is a catch plate 166 with handle 168. The catch plate 166 secures to the bracket 170 (of outer unit 150) and bracket 172 (of outer unit 152) by a pin 174. Pin 174 also extends through opening 178 on the body 180 of the catch plate 166. Rotating the catch plate 166 about pin 174 towards the upper shaft 16 causes a catch plate receiving member 182, illustrated herein as an opening, to engage with a catch plate engaging member 184, illustrated herein as an outwardly directed projection member. The catch plate engaging member 184 is sized and shaped to engage and secure within catch plate receiving member 182.

To lock or unlock the locking unit 62 about the upper shaft 16 of the locking rack body 12, a user unlocks locking lever door 186 by inserting keys 188 into a key way 190 of a lock 192. The locking plate 194 moves in or out of a locking plate receiving channel 196 cut into outer units 150 and 152, thereby locking or unlocking the locking lever door 186 in place. To further maintain the locking lever door 186 in position, opening 197 within a lever 198 secures to a locking pin 200 (FIG. 6C). A lock cover 202 is rotatably secured to the locking lever door 186 through pin 204 and brackets 206 and 208. While lock 192 is shown using a key entry, use of a keyless lock may be used as well.

At the bottom portion 210 of the locking lever door body 212 are cams 214. The cams 214 are sized and shaped to fit within partial opening 216 (i.e. the opening does not extend through the outer units 150 and 152). Accordingly, the cams 214 are designed to engage with a bearing surface 218. As the locking lever door 186 is traversed from a locking position, see FIG. 6B, and unlocking position, see FIG. 6C, a cam lock 220 contacts or moves away from upper shaft 16 of the locking rack body 12. The cam lock 220 comprises a slide member 222 having a longitudinal slotted opening 224 sized and shaped to receive a cam lock pin 226. The cam lock 220 is designed to fit within guide members 228 and 230, allowing the cam lock pin 226 to engage the longitudinal slotted opening 224 down side wall 225 (and along the opposing side wall, not shown) and a cam lock pin receiving member 232. The cam lock pin receiving member 232 is orientated off center (of center point 234, see FIG. 6D) of cam 214. FIG. 6D illustrates the cam horizontal axis 235A and the cam vertical axis 235B. Once the cams 214 are inserted within the partial opening 216 and resting against bearing surface 218, the cams 214 are prevented from moving in a horizontal (in the same direction as the cam horizontal axis 235A), or side to side direction. However, because of the slotted opening 224, the cams 214 are permitted to move in an up/down, or vertical direction (in the same direction as the cam vertical axis 235B). As shown in FIG. 6B, cam lock pin receiving member 232 with cam lock pin 226 positioned therein is located off center, but aligned with the cam horizontal axis 235A. In this position, a locking rack body upper shaft contacting member 236, illustrated herein as a rubber pad, presses against and contacts the upper shaft 16 of the locking rack body 12, thereby locking in place. As the locking lever door 186 is moved downwardly, see arrow 238 on FIG. 6C, the cam lock pin 226 moves within longitudinal slotted opening 224. Because the cams 214 are secured to bearing surface 218, the motion of the locking lever door 186 results in the cam lock pin 226, still positioned in an off center orientation, to be aligned with the cam vertical axis 235B. This movement causes the locking rack body upper shaft contacting member 236 to move away from the upper shaft 16 of the locking rack body 12 (unlocking position).

As illustrated, the locking rack body upper shaft contacting member 236 contains guide rails 240 and 242 sized and shaped to engage with cam lock channels 244 and 246. Additionally, the cam lock 220 contains a cut out region 248 sized and shaped to align and received a portion of the locking lever door 186 as it is traversed between the locking position and the unlocking position. Elongated bar 66 can be inserted and secured within opening 250.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that, while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for locking equipment comprising a locking rack body configured to maintain equipment in a secured position when engaged therewith, said locking rack body comprising:
an upper shaft configured to engage with at least one first portion of said equipment;
a lower shaft configured to engage with at least one second portion of said equipment;
an upper equipment securing member configured for over-the-top engagement with a piece of equipment;
a lower equipment securing member; and
a locking unit configured to maintain said upper equipment securing member in a locked or unlocked position about said locking rack body upper shaft, said locking unit having a locking rack body upper shaft contacting member configured to engage with said locking rack body upper shaft in a locked position, and disengage with said locking rack body upper shaft in an unlocked position.

2. The device for locking equipment according to claim 1 wherein said locking unit is slidably engaged with said locking rack body upper shaft.

3. The device for locking equipment according to claim 1 further including a cam lock, said cam lock having a body configured to engage with said locking rack body upper shaft contacting member.

4. The device for locking equipment according to claim 1 wherein said upper equipment securing member comprises two elongated bars separated by a distance and space, and at least one bracket configured to maintain said two elongated bars in a preferred orientation.

5. The device for locking equipment according to claim 1 wherein said upper equipment securing member is rotatable at least 180 degrees about said locking rack body upper shaft.

6. The device for locking equipment according to claim 1 wherein said locking rack body upper shaft connects to said locking rack body lower shaft through an upper shaft-lower shaft bracket.

7. The device for locking equipment according to claim 1 wherein said locking rack body upper slidably engages a portion of said upper shaft-lower shaft bracket.

8. The device for locking equipment according to claim 1 wherein said locking unit comprises a lever door having at least one cam.

9. The device for locking equipment according to claim 1 wherein said locking unit comprises a slotted opening sized and shaped to received and secure thereon a rotating member.

10. The device for locking equipment according to claim 9 wherein said rotating member engages said at least one cam in an off center orientation.

11. The device for locking equipment according to claim 9 wherein said at least one cam is rotatably connected to said cam lock, wherein rotation of said at least one cam in one direction maintains said rotating member in an off center orientation, but aligned with a vertical axis of said at least one cam.

12. The device for locking equipment according to claim 9 wherein said at least one cam is rotatably connected to said cam lock, wherein rotation of said at least one cam in one direction maintains said rotating member in an off center orientation, but aligned with a horizontal axis of said at least one cam.

13. The device for locking equipment according to claim 1 further including a stop member secured to said locking rack body upper shaft.

14. The device for locking equipment according to claim 1 further including a hose clip sized and shaped to receive and hold a hose.
